(19) United States
(12) Patent Application Publication
(10) Pub. No.: US 2019/0107837 A1
(43) Pub. Date: Apr. 11, 2019

(54) CAMERA DRONE AND CONTROLLING METHOD THEREOF

(71) Applicant: Tae-Ki YUN, Seoul (KR)

(72) Inventor: Tae-Ki YUN, Seoul (KR)

(21) Appl. No.: 16/149,669

(22) Filed: Oct. 2, 2018

(30) Foreign Application Priority Data
Oct. 5, 2017 (KR) 10-2017-0128546

(51) Int. Cl. G05D 1/00; H04N 5/232; H04N 5/445; G05D 1/10; B64C 39/02

(52) U.S. Cl. CPC G05D 1/0094; H04N 5/23299; H04N 5/23203; H04N 5/44591; H04N 5/2628; H04N 5/23218; G05D 1/101; G05D 1/0011; B64C 39/024; H04N 5/23293

(57) ABSTRACT

A camera drone according to an exemplary embodiment of the present disclosure includes a frame, a driving unit which is equipped in the frame and moves the camera drone, a camera which is rotatable with respect to a first axis on the frame and shoots an object, a display which is rotatable with respect to a second axis on the frame and outputs an image for the shot object, and a controller which is mounted in the frame and controls at least one of the camera and the display to be rotated.

### CROSS-REFERENCE TO RELATED APPLICATIONS

This application claims the priority of Korean Patent Application No. 10-2017-0128546 filed on Oct. 5, 2017, in the Korean Intellectual Property Office, the disclosure of which is incorporated herein by reference.

### BACKGROUND

### Field

The present disclosure relates to a camera drone and a controlling method thereof and more particularly, to a drone controller including a display which outputs an image which is being shot and a control method thereof.

### Description of the Related Art

In order to confirm a preview image at the time of shooting images using a camera equipped in a drone, the user needs to receive images which are being shot by the camera of the drone using a portable terminal and check the received images. Therefore, when the user checks a screen of the portable terminal while manipulating the drone, there may be a problem in that the user cannot identify a flight status of the drone for a predetermined period of time. Specifically, an unintentional drone operation may occur during the checking of the portable terminal, which may cause dangerous situations such as collision of the drone.

Further, when the user takes a selfie using a camera equipped in the drone, the user needs to look at the camera of the drone and check a preview image through a portable terminal, and then takes an actual photograph, so that the user's experience for selfie shooting is hampered. Further, there may be an inconsistency between an actually-shot image and the preview image. Further, when the user changes the posture, it is inconvenient because the preview cannot be immediately checked.

Nevertheless, a selfie-drone which can simultaneously check a preview screen of the shot image and a flight status of the drone has not been provided.

### RELATED ART DOCUMENT

### Patent Document

Korean Unexamined Patent Application Publication No. 2017-0097819

### SUMMARY

An object to be achieved by the present disclosure is to provide a drone which can check a flight status of a drone and an image which is being shot by a camera at one sight and a control method thereof.

Specifically, an object to be achieved by the present disclosure is to provide a drone including a display for providing a preview function for an image which is being shot and a control method thereof.

Another object to be achieved by the present disclosure is to provide a drone which stably maintains a pose of a fuselage even in a tilting operation of a tilting component and a control method thereof.

Still another object to be achieved by the present disclosure is to provide a drone which analyzes an image obtained from a camera to automatically change a coordinate to an optimal shooting position and a control method thereof.

Technical objects of the present disclosure are not limited to the aforementioned technical objects and other technical objects which are not mentioned will be apparently appreciated by those skilled in the art from the following description.

According to an aspect of the present disclosure, a camera drone includes a frame, a driving unit which is equipped in the frame and moves the camera drone, a camera which is rotatable with respect to a first axis on the frame and shoots an object, a display which is rotatable with respect to a second axis on the frame and outputs an image for the shot object, and a controller which is mounted in the frame and controls at least one of the camera and the display to be rotated.

According to an aspect of the present disclosure, a control method of a camera drone includes: receiving a tilting control signal for a first component of a camera drone, first tilting the first component in response to the reception of the control signal; determining whether a direction of a second component is within a first angle range in response to the first tilting, and flying the drone to change a coordinate of the camera drone on a three-dimensional space, based on information of the first tilting when a direction of the second component is within the first angle range.

In an exemplary embodiment, the control method of a camera drone includes: second tilting a direction of the second component within the first angle range when the direction of the second component is out of the first angle range, and when a sum of a second tilting response value according to the second tilting and a first tilting response value according to the first tilting exceeds a predetermined value, flying the drone to change the coordinate of the camera drone on the three-dimensional space based on the sum.

According to an exemplary embodiment of the present disclosure, a desired image may be obtained through a camera of a drone while looking at a screen of a drone. Specifically, a preview function may be provided through a display toward a user who gazes at a camera of the drone.

According to another exemplary embodiment of the present disclosure, even though at least one of a camera shooting direction and an output direction of a display is changed, the drone maintains the posture to stably fly. Further, at the time of shooting or outputting an image, a predetermined posture is maintained so that a user's experience for image shooting and a preview through a drone may be increased.

According to still another exemplary embodiment of the present disclosure, after identifying at least one object using a camera, a posture, a direction, and an altitude of a drone are automatically changed so that the object is located in a specific area of a display. Therefore, the user may always obtain a picture located in a desired area of a screen at the time of shooting.

The effects of the present disclosure are not limited to the technical effects mentioned above, and other effects which are not mentioned can be clearly understood by those skilled in the art from the following description

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exemplary view of a drone and a drone controller according to an exemplary embodiment of the present disclosure;

FIG. 2 is an exemplary view of a camera drone according to another exemplary embodiment of the present disclosure;

FIGS. 3A-3C are exemplary views for explaining a tilting component of a drone which are referenced in some exemplary embodiments of the present disclosure;

FIGS. 4A and 4B are exemplary views for explaining an opening unit and a cooling function unit of a drone which is referenced in some exemplary embodiment;

FIG. 5 is a block diagram of a drone controller according to another exemplary embodiment of the present disclosure;

FIGS. 6A and 6B are exemplary views for explaining fuselage control of a drone according to the tilting of a camera, which is referenced in some exemplary embodiments of the present disclosure;

FIGS. 7A and 7B are exemplary views for explaining fuselage control of a drone according to tilting of a display, which is referenced in some exemplary embodiments of the present disclosure;

FIG. 8 is an exemplary view for explaining a predetermined output direction of a display, which is referenced in some exemplary embodiments of the present disclosure;

FIG. 9 is an exemplary view for explaining an operation of a tiling component in accordance with identification of a drone controller, which is referenced in some exemplary embodiments of the present disclosure;

FIGS. 10A, 10B, 11A and 11B are exemplary views for explaining a movement function of a drone for controlling a display state, which is referenced in some exemplary embodiments of the present disclosure;

FIG. 12 is an exemplary view for explaining a power reduction environment of a drone, which is referenced in some exemplary embodiments of the present disclosure;

FIGS. 13A to 13C are exemplary views for explaining a cooling function of a drone, which is referenced in some exemplary embodiments of the present disclosure;

FIG. 14 is a flowchart of a control method of a camera drone according to still another exemplary embodiment of the present disclosure; and

FIG. 15 is a flowchart of a shooting position changing method of a drone in accordance with an image analysis according to still another exemplary embodiment of the present disclosure.

### DETAILED DESCRIPTION OF THE PREFERRED EMBODIMENTS

Hereinafter, exemplary embodiments of the present disclosure will be described in detail with reference to the accompanying drawings. Advantages and features of the present disclosure, and methods for accomplishing the same will be more clearly understood from the exemplary embodiments described below with reference to the accompanying drawings. However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the invention, and the present disclosure will be defined by the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined. The terms used in the present specification are for explaining the embodiments rather than limiting the present invention. Unless particularly stated otherwise in the present specification, a singular form also includes a plural form.

In the present disclosure, a drone includes a camera for shooting an external object and may be referred to as a camera drone or a selfie drone.

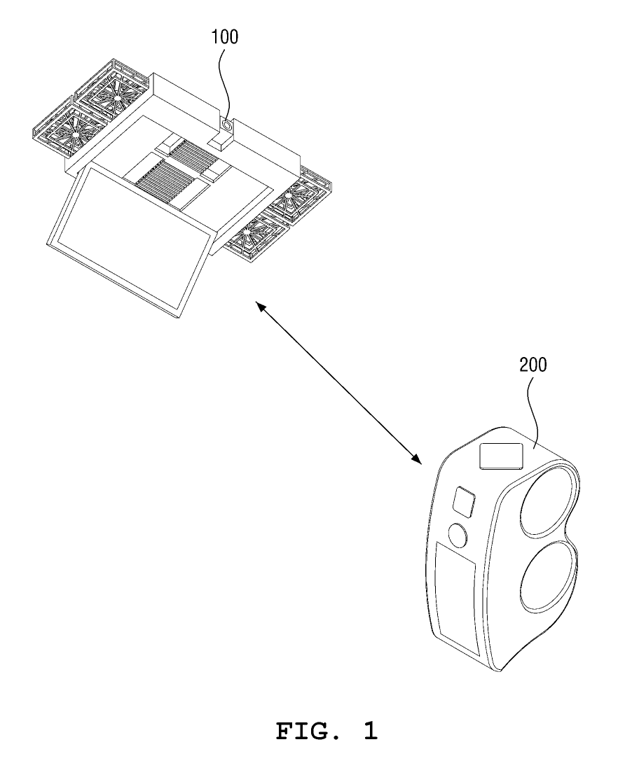

FIG. 1 is an exemplary view of a drone and a drone controller according to an exemplary embodiment of the present disclosure.

Referring to FIG. 1, a drone 100 and a drone controller 200 are computing devices which communicate with each other. Specifically, the drone 100 may include a camera and a display. According to an exemplary embodiment of the present disclosure, operations and functions of the drone 100 may be controlled by the drone controller 200. Specifically, the drone 100 receives a control signal generated in the drone controller 200 and determines a flight direction and/or a flight altitude and operates based on the received control signal. Further, the drone 100 may perform an operation in accordance with a predetermined flight mode, based on the received control signal. Furthermore, the drone 100 may control a function and an operation of each component of the drone 100 based on the received control signal.

The drone 100 may be a drone which is widely known in the technical field of the present disclosure, and specifically, may be a selfie mini-drone.

The drone controller 200 may receive various commands and settings from a user, and for example, the input may include not only a button input and a touch input, but also a motion input of a user which is performed to the drone controller 200. To this end, the drone controller 200 may include at least one sensor for recognizing a motion of a user, such as a gyro sensor, an acceleration sensor, and a geomagnetic sensor.

The drone controller 200 receives a motion input of the user and generates a control signal for controlling the drone 100 based on the motion input. The drone controller 200 may set in advance a type of recognizable motions.

The drone controller 200 detects at least one of an acceleration change, a direction change, and an angular velocity change of the drone controller 200 and determines what kind of predetermined motion is the user's motion input.

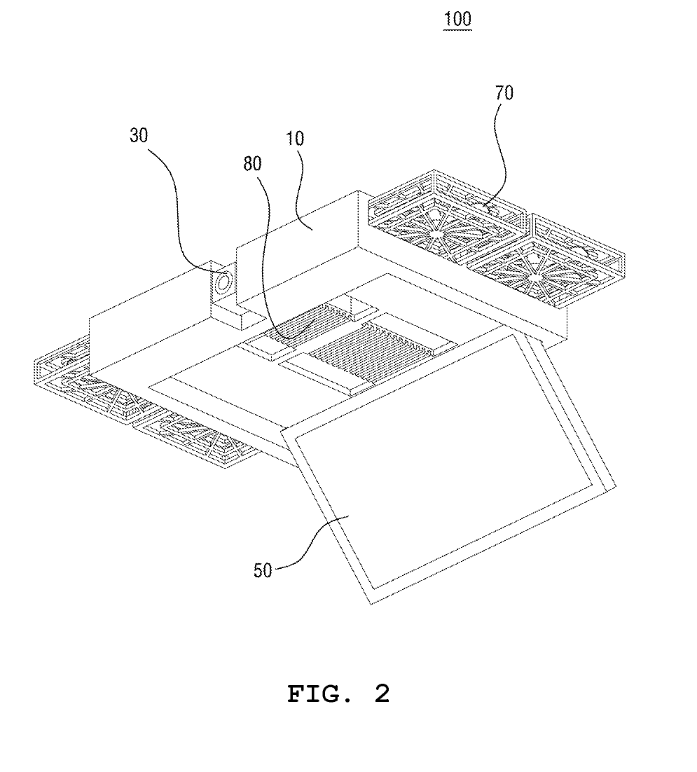

Hereinafter, referring to FIGS. 2 to 5, the function and the operation of the drone 100 will be described in more detail. FIG. 2 is an exemplary view of a camera drone according to another exemplary embodiment of the present disclosure.

In FIG. 2, as an example of a camera drone, a flat type drone is exemplified and a frame 10 may include a controller, a circuit configuration, and a mechanical device for operations of a component. The frame 10 is a housing of the drone 100 and includes at least some of the components of the drone 100 therein and mounts other components outside. For example, in order to mount the other components outside of the frame, the frame 10 includes an opening unit on an outer surface to accommodate the components. As another example, the frame 10 includes a recessed surface structure at one side and some components may be folded or unfolded in the recessed surface structure.

Referring to FIG. 2, a camera 30 and a display 50 are exposed from the outside of the frame 10 of the drone 100. The camera 30 and the display 50 are provided in the drone 100 to be rotatable at the outside of the frame 10, for example, may rotate with respect to one axis of a hinge device.

Specifically, the display 50 may rotate with respect to one axis of the hinge device which is mounted in the frame 10 or at the outside of the frame 10. For example, in a shooting mode of the camera 30 or an output mode of the display 50, the display 50 rotates outwardly from the drone 100 to output an image. As another example, not in the shooting mode of the camera 30 or the output mode of the display 50, the display 50 may rotate to cover a bottom surface of the drone 100. The display 50 is folded on a recessed surface at a lower end of the frame 10 to cover the bottom surface of the drone 100.

At least some of the circuit components and the mechanical devices for implementing the operation and the function of the camera 30 and the display 50 may be provided in the frame 10.

Further, in FIG. 2, it is illustrated that a driving unit 70 of the drone 100 includes four propellers. When the drone 100 is not in a flight mode, the driving unit 70 is accommodated in the frame 10 and in the flight mode of the drone 100, the driving unit 70 may outwardly slide in a left and right direction of the frame 10. When the driving unit 70 outwardly slides in a left and right direction of the frame 10, the propellers which are equipped to provide lift to the fuselage of the drone 100 rotate to move the drone 100 to a specific altitude or maintain the drone 100 at a specific altitude. Further, the driving unit 70 may include a plurality of propellers and move a horizontal coordinate of the drone 100 by adjusting the lift between the plurality of propellers. In order to provide a rotational force to the propellers, the driving unit 70 may include at least one motor (not illustrated).

According to an exemplary embodiment of the present disclosure, the drone 100 may include a cooling function unit 80. The cooling function unit 80 cools down an internal temperature of the drone 100 to contribute a performance efficiency of a power supply unit (not illustrated) and a controller of the drone 100.

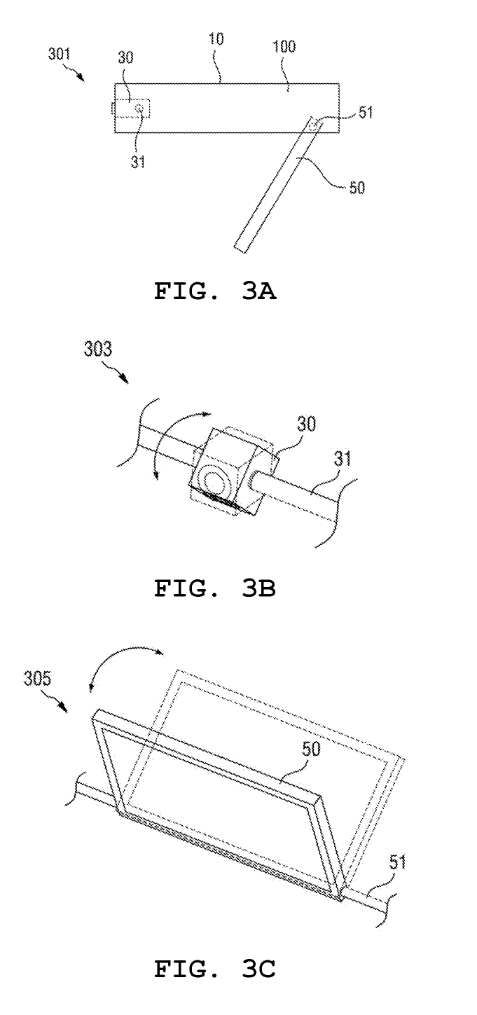

FIGS. 3A to 3C are exemplary views for explaining a tilting component of a drone, which is referenced in some exemplary embodiments of the present disclosure. For example, a tilting component of the drone may include a camera 30 and a display 50.

An exemplary view 301 is a side view of the drone 100 in which some components of the camera 30 are mounted in the frame 10 and the remaining components for shooting may be provided in the frame 10 to be exposed to the outside. The display 50 is folded on a recessed surface provided at a lower end of the frame 10 to configure a bottom surface of the drone 100 and is unfolded from the recessed surface to output an image to an external direction of the drone 100.

Referring to the exemplary views 301 and 303, the camera 30 rotates using a hinge device in the frame 10 and the hinge device may include a first axis 31 for this purpose. Here, the first axis refers to a device for rotating the camera 30.

Referring to the exemplary views 301 and 305, the display 50 rotates using a hinge device inside or outside the frame 10 and the hinge device may include a second axis 51 for this purpose. Here, the second axis refers to a device for rotating the display 50.

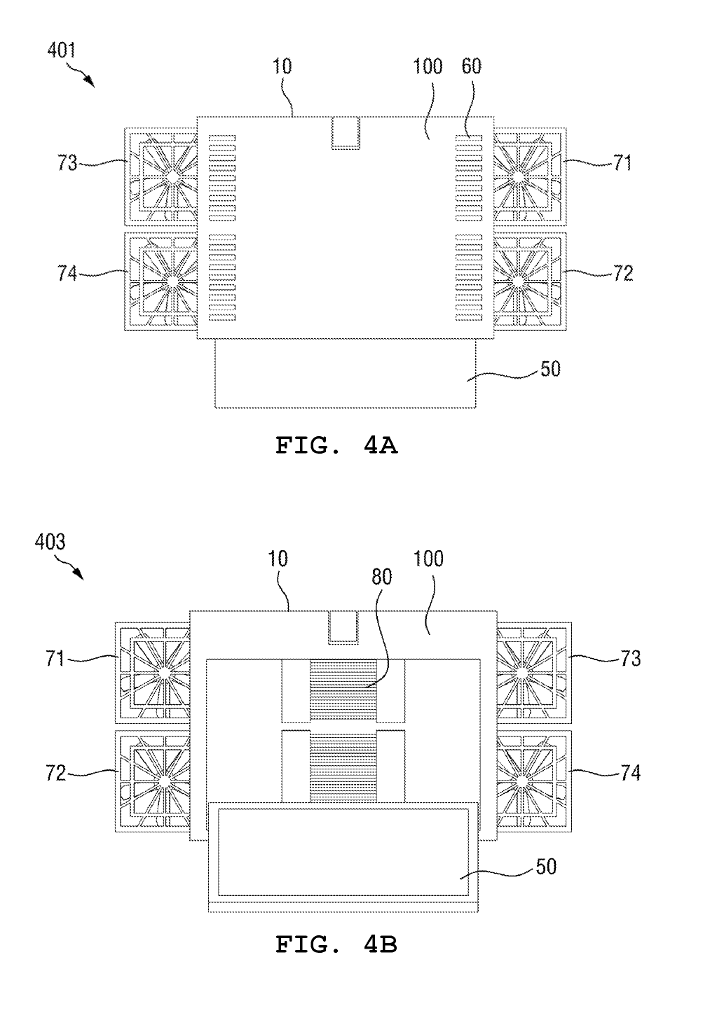

FIGS. 4A and 4B are exemplary views for explaining an opening unit and a cooling function unit of a drone, which is referenced in some exemplary embodiment. In FIGS. 4A and 4B, as a component of the driving unit 70 referenced in FIG. 2, four propellers 71, 72, 73, and 74 are illustrated. Specifically, each propeller is mounted in an open type frame which accommodates the propellers and each open type frame may slide in or out in the frame 10 according to a flight mode of the drone 100. A sliding device which provides a sliding function to the open type frame of each propeller may be provided in the frame 10.

An exemplary view 401 is a plan view of the drone 100 and illustrates that the drone 100 includes a plurality of opening units 60 which introduces air into an upper end of the frame 10. The propellers 71, 72, 73, and 74 are configured such that a part of the open type frame of each of the propellers 71, 72, 73, and 74 is located in the frame 10 and the remaining part is located outside the frame 10. In the part located in the frame 10, as the propellers rotate, the air may be introduced in the frame 10 through the opening unit 60. The introduced air cools the controller. In order to effectively cool the controller by the air introduced therein, a passage configuration which serves as a movement path of the introduced air may be provided in the frame 10.

An exemplary view 403 is a bottom view of the drone 100 and illustrates a structure having a plurality of recessed grooves as the cooling function unit 80 to increase an air contact area at a lower end of the frame 10. The plurality of recessed grooves is located on a lower exterior surface of the frame 10 and performs air contact when the display 50 rotates outwardly from the drone 100 to expose a lower end of the frame 10.

When the display 50 is unfolded to output an image in an outward direction, heat is generated and the power consumption is increased, so that a power efficiency of the power supply unit and a calculating performance of the controller are degraded. When the cooling is performed through air contact in the cooling function unit 80 as illustrated in the exemplary view 401, it may contribute to the performance efficiency of the controller and the power supply unit.

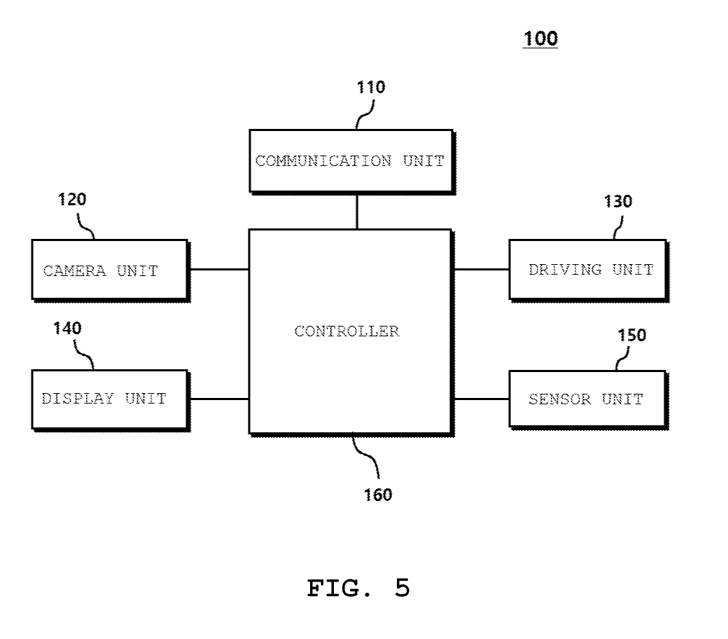

FIG. 5 is a block diagram of a drone controller according to another exemplary embodiment of the present disclosure.

Referring to FIG. 5, the drone 100 includes a communication unit 110, a camera unit 120, a driving unit 130, a display unit 140, a sensor unit 150, and a controller 160.

The communication unit 110 supports communication between the drone 100 and a drone controller 200. The communication unit 110 may support at least one of radio control (RC) communication, short range communication, Internet communication, and wireless mobile communication. To this end, the communication unit 110 may include at least one communication module which is well-known in the technical field of the present disclosure.

Specifically, the communication unit 110 may receive various control signals from the drone controller 200 to control the drone 100 according to an exemplary embodiment of the present disclosure.

The camera unit 120 may include a camera 30, a hinge device for rotating the camera 30, and a circuit device which converts an image input through the camera 30 into an electrical signal.

When a still image or a moving image is input from the outside of the drone 100 through the camera 30, the circuit device of the camera unit 120 may transmit the input image to the display unit 140 and/or the controller 160. Further, the camera unit 120 may rotate the camera 30 in response to a control command of the controller 160 and to this end, the hinge device of the camera unit 120 may operate.

The driving unit 130 provides lift for a flight of the drone 100. The driving unit 130 provides taking-off, altitude changing, hovering, and landing functions of the drone 100 and to this end, may include one or more propellers 70 referenced in FIG. 2. When a plurality of propellers 70 is equipped, a power which is supplied to each propeller is controlled so that a flight coordinate of the drone 100 on a three-dimensional space may be moved. Three-dimensional space refers to a space including a vertical coordinate and a plane coordinate where the drone 100 can fly.

The driving unit 130 may include a motor which provides a power to one or more propellers 70. Even though not illustrated, a power supply unit supplies the electrical energy to the motor and a battery which is widely used in the field to which the present disclosure belongs may be applied as the power supply unit. Specifically, a detachable and chargeable battery may be used as the battery. The driving unit 130 may include a sliding device which slides the propeller 70 to the outer direction of the frame 10.

The display unit 140 may include a display 50, a hinge device for rotating the display 50, and a circuit device which converts an image input through the camera 50 into an electrical signal or signals received from the controller 160 into an analogue signal.

The sensor unit 150 senses a tilting degree, an altitude, and a flight direction of the drone 100. To this end, the sensor unit 150 includes at least one sensor which is capable of recognizing status information of the drone 100, such as a gyro sensor, an acceleration sensor, or a geomagnetic sensor.

The controller 160 controls an overall operation of each component of the above-described drone 100. The controller 160 may be configured to include at least one of a central processing unit (CPU), a microprocessor unit (MPU), a micro controller unit (MCU), an application processor (AP), and an arbitrary processor which is well known in the technical field of the present disclosure. The controller 160 may perform an arithmetic operation for at least one application or program to execute the method according to the exemplary embodiments of the present disclosure. Specifically, the controller 160 may generate a signal for controlling a flight status of the drone and an operation of each component of the drone 100, based on a control signal received through the communication unit 110 of the drone controller 200 referenced in FIG. 1.

Even though not illustrated, the drone 100 may further include a memory unit and a storage unit. The memory unit may be configured by a volatile memory which is capable of performing record decryption and has a high reading or writing speed. As an example, the memory unit may include any one of an RAM, a DRAM, and an SRAM.

The storage unit may non-transitorily store various information for embodying the exemplary embodiment of the present disclosure. The storage unit may be configured by including a nonvolatile memory such as a read-only memory (ROM), an erasable programmable ROM (EPROM), an electrically erasable programmable ROM (EEPROM), and a flash memory, a hard disk, a removable disk, or any computer-readable recording medium which is well known in the technical field of the present disclosure.

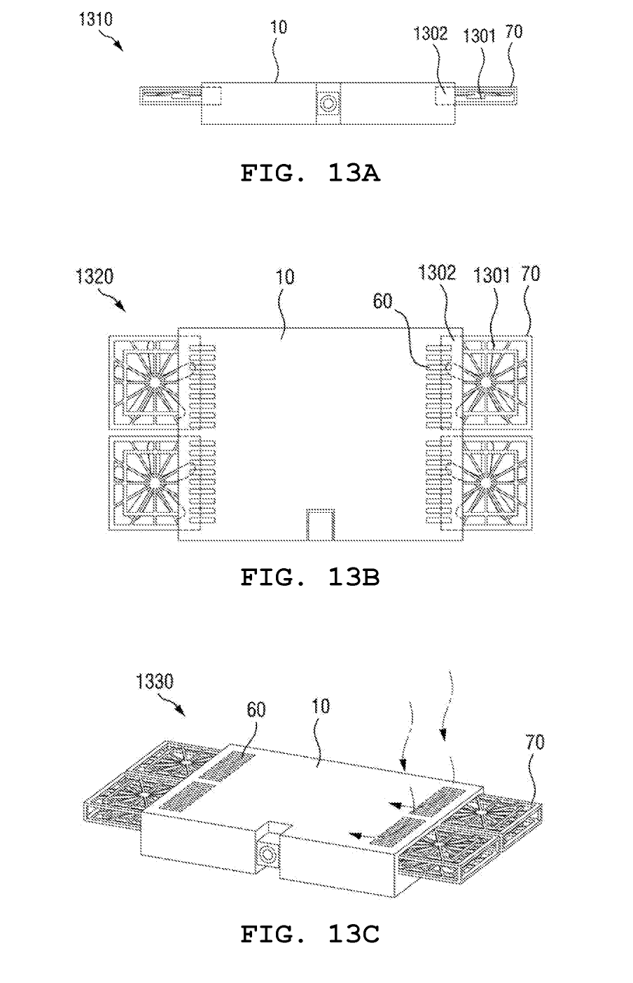

According to another exemplary embodiment of the present disclosure, the drone 100 may include an input unit for controlling a power on an outer surface of the frame 10. The input unit may be a physical button device, but the exemplary embodiment of the present disclosure is not limited thereto and various devices such as a pressure sensitive type touch sensor device and a capacitive touch sensor device may be applied. The input unit for power control will be described below with reference to FIG. 13.

Hereinafter, the function and the operation of the drone 100 according to the exemplary embodiment of the present disclosure will be described in more detail based on the description of FIGS. 1 to 5. Hereinafter, the function and the operation of the drone 100 are implemented by the control of the controller 160 of FIG. 5.

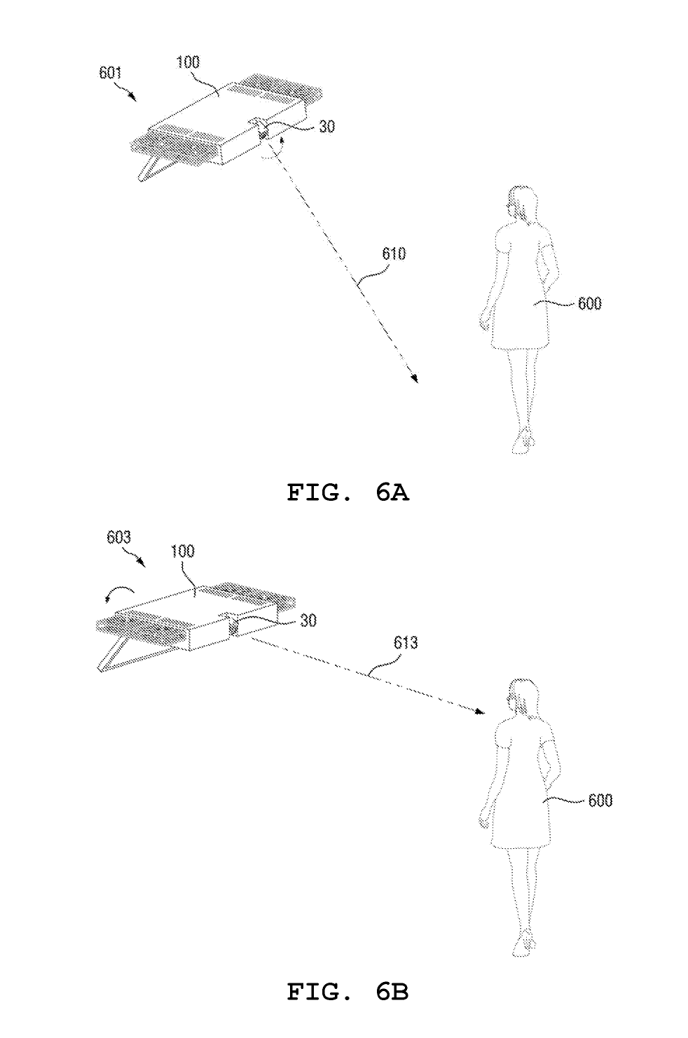

FIGS. 6A and 6B are exemplary views for explaining fuselage control of a drone according to tilting of a camera, which is referenced in some exemplary embodiments of the present disclosure.

In an exemplary view 601, a direction 610 of a camera of a drone 100 is not directed to a user 600. The controller 160 may control the camera 30 to rotate from a first direction to a second direction. In this case, the controller 160 may control the driving unit 130 such that a posture of the drone 100 which is flying is changed in accordance with rotation of the camera 30 from the first direction to the second direction.

Referring to the exemplary view 601, a control signal which rotates a direction of the camera 30 to be directed to the user 600 may be input to or received by the drone 100. Therefore, when the camera 30 rotates, a reaction energy which is generated by the tilting of the camera 30 may act on the drone 100. The reaction energy may cause the change of at least one of an altitude, a direction, and a tilting degree of the drone 100.

In the exemplary view 603, as the camera 30 rotates from a direction 610 to a direction 613, it is assumed that the at least one change of the drone 100 is generated. This is referred to as a posture change of the drone 100.

The sensor unit 150 may identify the posture information of the drone 100 by detecting the at least one change. The controller 160 may compare the identified posture information and posture information to be compared, such as a posture before the rotation of the camera 30 or predetermined posture information. The posture information to be compared may be recorded in the storage unit of the drone 100. When a difference between the identified posture information and the posture information to be compared is out of a predetermined range, the controller 160 may control the posture of the drone 100 to be changed again.

The above-described posture correction of the drone 100 provides an effect such that the camera 30 rotates to a target direction to obtain a desired shooting composition. That is, even though the camera 30 rotates according to the control signal, when the posture of the drone 100 is changed, the desired shooting composition cannot be obtained, but the present exemplary embodiment may solve the above-mentioned problem.

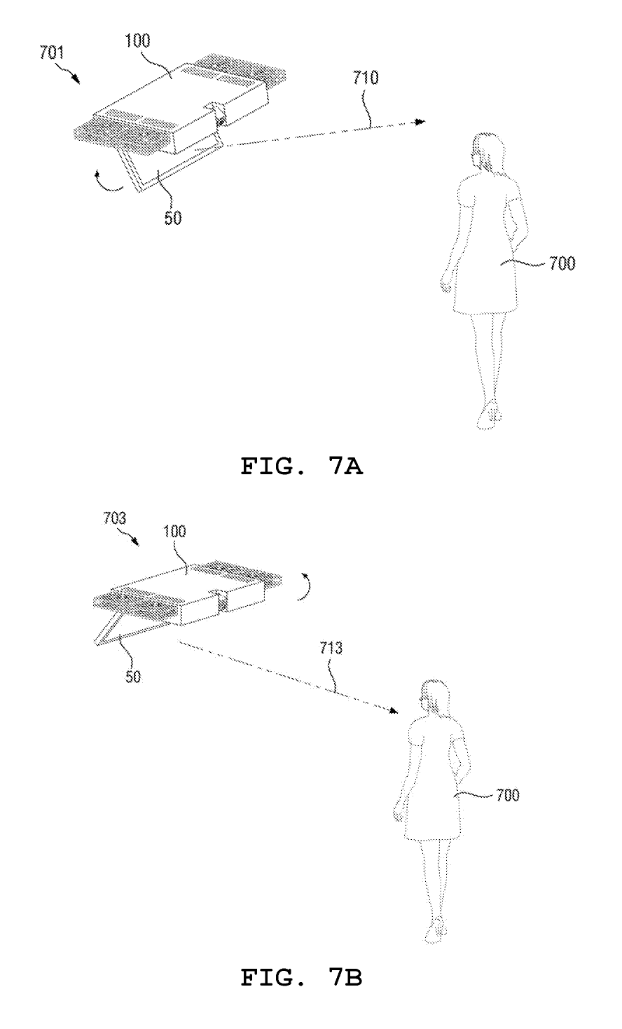

FIGS. 7A and 7B are exemplary views for explaining fuselage control of a drone according to tilting of a display unit, which is referenced in some exemplary embodiments of the present disclosure.

In an exemplary view 701, a direction 710 of a display of a drone 100 is not directed to a user 700. The controller 160 may control the display 50 to rotate from a first direction to a second direction. In this case, the controller 160 may control the driving unit 130 such that a posture of the drone 100 which is flying is changed in accordance with rotation of the display 50 from the first direction to the second direction.

Referring to the exemplary view 701, a control signal which rotates a direction of the display 50, that is, an image output direction to a direction of the user 700 may be input to or received by the drone 100. Therefore, when the display rotates, a reaction energy which is generated by the tilting of the display 50 may act on the drone 100. The reaction energy may cause the change of at least one of an altitude, a direction, and a tilting degree of the drone 100.

In the exemplary view 703, as the camera 50 rotates from a direction 710 to a direction 713, it is assumed that the posture change of the drone 100 is generated.

The sensor unit 150 may identify the posture information of the drone 100 by detecting the at least one change. The controller 160 may compare the identified posture information and posture information to be compared, such as a posture before the rotation of the display 50 or predetermined posture information. The posture information to be compared may be recorded in the storage unit of the drone 100. When a difference between the identified posture information and the posture information to be compared is out of a predetermined range, the controller 160 may control the posture of the drone 100 to be changed again.

The above-described posture correction of the drone 100 provides an effect such that the display 50 rotates to a target direction to obtain a desired image output direction. That is, even though the display 50 rotates according to the control signal, when the posture of the drone 100 is changed, a desired image output direction cannot be obtained, but the present exemplary embodiment may solve the above-mentioned problem.

In FIGS. 6A, 6B, 7A and 7B, an exemplary embodiment in which when a reaction energy is applied to the fuselage of the drone 100 in accordance with the rotation of the camera 30 or the display 50, a posture change of the drone 100 is corrected has been described, but the exemplary embodiment of correcting the posture change of the drone 100 is not limited thereto. According to another exemplary embodiment of the present disclosure, an effect caused by tilting any one of the camera 30 and the display 50 is prevented from being applied to the other.

Specifically, it is described that the camera 30 is tilted. The controller 160 may control the camera 30 to rotate from a first direction to a second direction. Further, the controller 160 may control the display unit 140 so as to adjust an image output direction of the display 50 in accordance with the rotation of the camera 30 from the first direction to the second direction. That is, when the reaction energy by the tilting of the camera 30 affects the drone 100, a posture of the drone 100 is changed and a direction of an image which is being outputted by the display 50 of the drone 100 is changed. In this case, the controller 160 controls to adjust the image output direction of the display 50 so that a desired image output direction may be provided to the user.

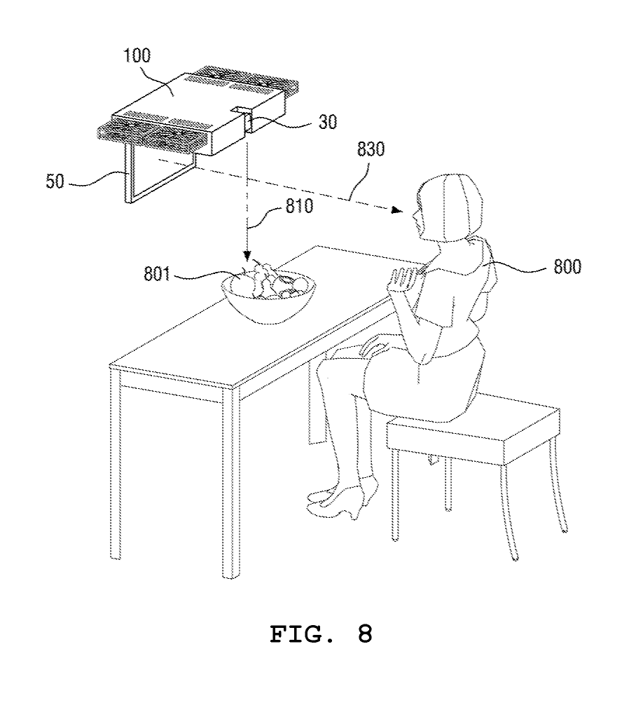

FIG. 8 is an exemplary view for explaining a predetermined output direction of a display unit, which is referenced in some exemplary embodiments of the present disclosure.

Referring to FIG. 8, the drone 100 hovers in a specific position by the manipulation of the drone controller by the user 800. The controller 160 may control the camera 30 to be directed to a predetermined first direction 810. Further, as the camera tilting in the predetermined first direction is identified, the controller 160 may control the display 50 to be directed to a predetermined second direction 830.

For example, when a user photographs a food 801, according to the related art, the user 800 tries to photograph the food toward the food direction above the food using a smart phone. In this case, a preview function may not be provided to the user 800 due to the photographing angle.

In contrast, according to the exemplary embodiment of the present disclosure, simultaneously with photographing the food 801, the preview function is also provided to the user 800.

According to the exemplary embodiment of the present disclosure, when a predetermined shooting mode is set, the controller 160 may control the camera 30 of the drone 100 to be directed to a direction 810 of the food 801.

When the camera 30 rotates to a direction 810, for example, a direction to perpendicular to the drone 100, the controller 160 identifies this and controls the display 50 to rotate to a direction 830, for example, a direction horizontal to the drone 100.

For example, the above-described predetermined shooting mode may be a food photographic mode, but is not limited thereto and when rather than a separate shooting mode, a perpendicularly rotating command of the camera 30 is received from the drone controller 200, the same exemplary embodiment may be applied.

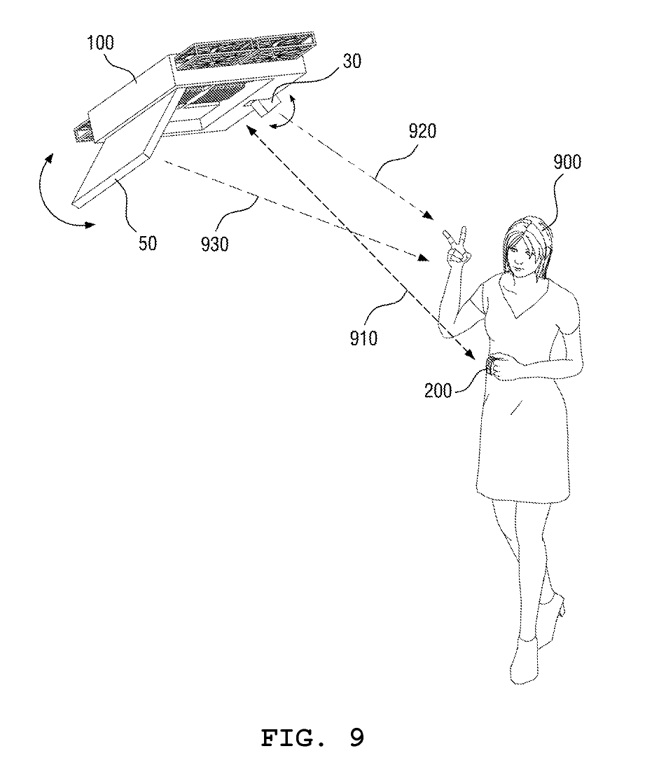

FIG. 9 is an exemplary view for explaining an operation of a tiling component in accordance with identification of a drone controller, which is referenced in some exemplary embodiments of the present disclosure. In FIG. 9, it is illustrated that the drone 100 receives a signal from the drone controller 200.

Referring to FIG. 9, the drone 100 may receive a control signal for controlling the drone 100 from the drone controller 200, through the communication unit 110. The controller 160 may identify a direction of the drone controller 200 as the control signal is received. For example, the controller 160 may analyze an intensity of received signal strength indication (RSSI) to identify a distance and a direction to the drone controller 200.

The controller 160 may control the direction of the camera 30 to rotate to an identified direction of the drone controller 200. To this end, it may be set in advance such that the direction of the camera 30 is determined based on a control signal received through the communication unit 110. Further, the controller 160 may control the direction of the display 50 to rotate to an identified direction of the drone controller 200. To this end, it may be set in advance such that the direction of the display 50 is determined based on a control signal received through the communication unit 110.

According to another exemplary embodiment of the present disclosure, not only the direction of the drone controller 200, but also a coordinate on a three-dimensional space may be identified. The controller 160 may control the camera 30 to shoot an image in an area set based on the coordinate of the drone controller 200 as an object. For example, the controller 160 may control an angle of the camera to shoot a predetermined space area with respect to a coordinate of the drone controller 200. Referring to FIG. 9, an area including a user 900 who carries a drone controller 200 with respect to a coordinate of the drone controller 200 may be a predetermined space area.

The controller 160 may rotate the camera 30 so that an image in the area set based on the coordinate of the drone controller 200 is output to a predetermined area on the display 50. For example, a body condition such as a height of the user 900 may be reflected in the space area set in advance based on the coordinate of the drone controller 200. As described in the above-described exemplary embodiment, when the camera 30 rotates to shoot the user 900, the controller 160 may adjust the angle of the camera 30 so that a result obtained by shooting the predetermined space area is located at a center of the display 50.

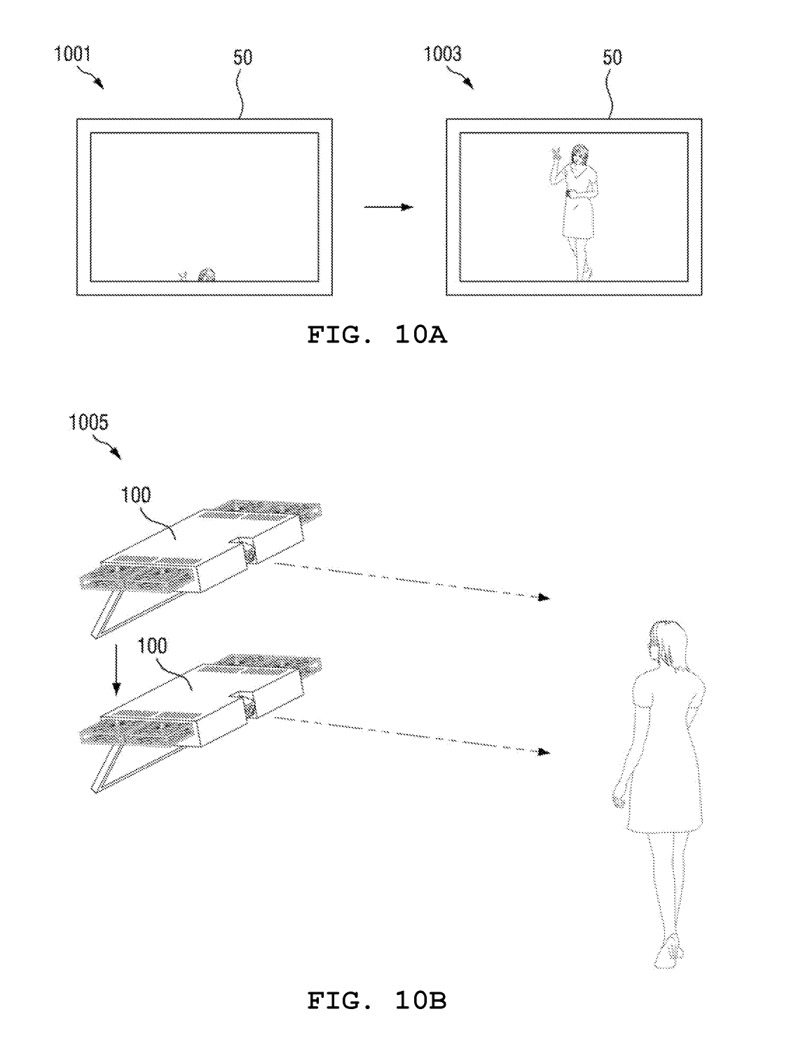

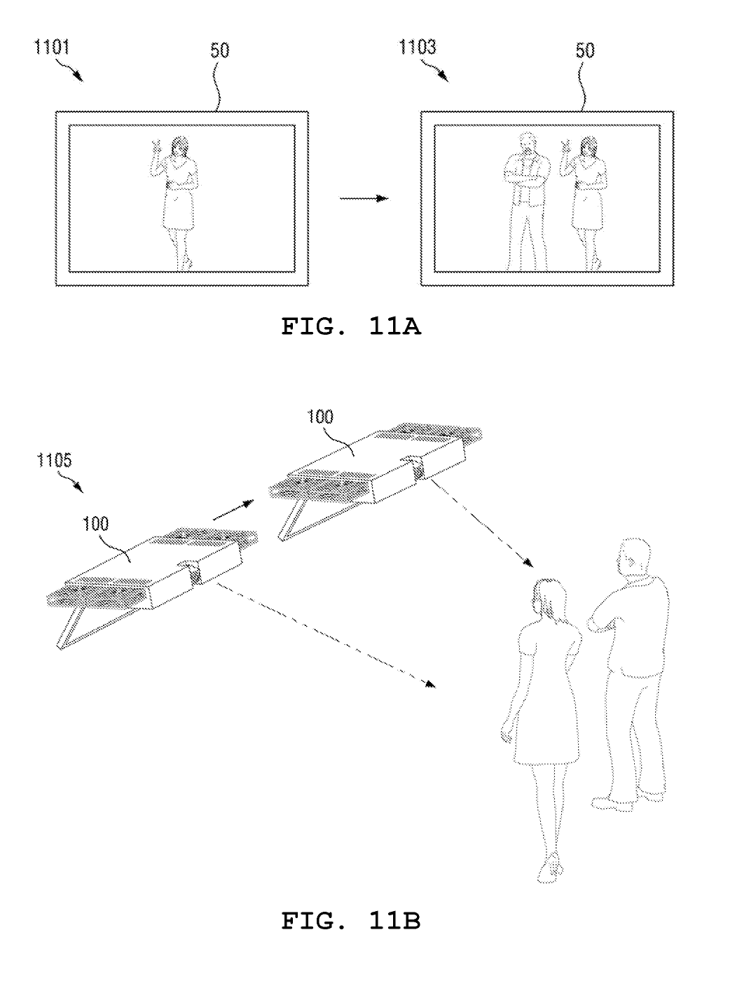

FIGS. 10A, 10B, 11A and 11B are exemplary views for explaining a movement function of a drone for controlling a display state, which is referenced in some exemplary embodiments of the present disclosure.

In an exemplary view 1001 of FIG. 10A, a shooting composition of the camera 30 of the drone is inappropriate for selfie shooting. Specifically, an altitude of the drone 100 is too higher than the user who is a subject. In this case, the display 50 outputs a user image which is input to the camera 30, but the output image may be a partial image of the entire user image. Referring to the exemplary view 1003, as the drone 100 moves, the user image may be output to a center area of the display 50.

To this end, the controller 160 analyzes a pixel of the display 50 to adjust the altitude of the drone 100 by controlling the driving unit 130 so that the output image is located at the center of the display 50.

Referring to the exemplary view 1005, the controller 160 identifies an output state of the display 50 as illustrated in the exemplary view 1001 and controls the driving unit 130 to output an image as illustrated in the exemplary view 1003 through the display 50, and thus adjusts the altitude of the drone 100.

In FIG. 10B, an exemplary embodiment in which a movement altitude of the drone 100 is adjusted such that the output image is located at the center on the display 50 under the control of the controller 160 has been described, but the exemplary embodiment of the present disclosure is not limited thereto. In another exemplary embodiment, the controller 160 may adjust at least one of the altitude and the direction of the drone 100 so that the output image is located in a predetermined area on the display 50.

An exemplary view 1101 of FIG. 11A illustrates that the camera 30 of the drone 100 shoots one user so as to be located at a center area of the display 50. It is assumed that flight altitude and direction of the flying drone 100 are maintained to output an image as illustrated in the exemplary view 1101. Further, one user who is currently being shot is referred to as a first object and the other subject than the user is referred to as a second object.

When the second object enters the shooting composition of the camera 30, the controller 160 detects this and outputs the first object and the second object to the display 50.

In the exemplary view 1101, when the first object is located at a center area of the display 50 and the second object enters, the current angle of the camera 30 and the flight direction of the drone 100 are maintained so that the first object is still located at the center area of the display 50 and the second object is located in a different area which is spaced apart from the center area by a predetermined distance.

In the exemplary view 1103, it is illustrated that both the first object and the second object are located at the center area of the display 50. To this end, as illustrated in the exemplary view 1105, the controller 160 may control the driving unit 130 to move the plane coordinate of the drone 100. Specifically, as the second object is additionally identified, the controller 160 calculates a display area to which the first object and the second object are output and moves the plane coordinate of the drone 100 such that the first object and the second object are output to the calculated display area. In another example, the controller 160 may move the altitude of the drone 100.

Although it has been mainly described that the direction of the camera 30 and the shooting direction of the drone 100 (the coordinate on the three-dimensional space) are changed so that an image is output to a specific area of the display 50 so far, the exemplary embodiment of the present disclosure is not limited thereto. According to still another exemplary embodiment of the present disclosure, the controller 160 may identify that the image output through the display 50 is tilted. That is, when the image is tilted with respect to a screen of the display 50, the controller 160 may control the driving unit 130 such that the image on the display 50 is output to be aligned with respect to the screen of the display 50. In this case, the camera 30 may shoot an image which is aligned with respect to the screen of the display 50 by changing the altitude, the plane coordinate, and a tilting degree of the drone 100.

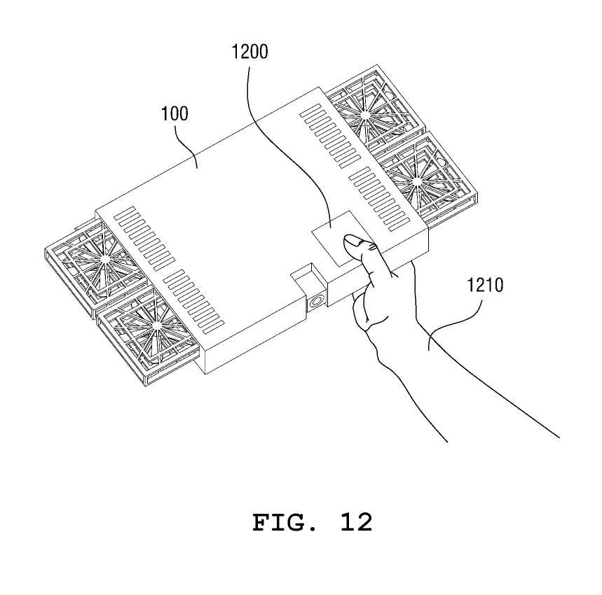

FIG. 12 is an exemplary view for explaining a power reduction environment of a drone, which is referenced in some exemplary embodiments of the present disclosure.

Referring to FIG. 12, the frame 10 of the drone 100 may further include a user input unit 1200 at one side. The controller 160 may sense the user input which is input to the user input unit 1200. For example, the user input unit 1200 may be a touch input device including a touch sensor, but the exemplary embodiment of the present disclosure is not limited thereto and the user input unit may be a button type input device.

As continuous user inputs are input through the user input unit 1200, the controller 160 may control the driving unit 130 to stop providing the power to the propeller included in the driving unit 130. As illustrated in FIG. 12, when the user 1210 seizes the drone 100 and applies an input to the user input unit 1200, the drone 100 stops the hovering function. To this end, the controller 160 controls the driving unit 130 so as not to supply the power to the propeller. By doing this, a battery power of the power supply unit may be saved.

When the user input is released, for example, when the touch input to the user input unit 1200 is released, the controller 160 may control the driving unit 130 to supply the power for hovering the drone 100 to the propeller. That is, the drone 100 is released in a space desired by the user so that the controller 160 may control the driving unit 130 to sense that the user input is not received from the user input unit 1200 and to allow the drone 100 to perform the hovering function.

FIGS. 13A to 13C are exemplary views for explaining a cooling function of a drone, which is referenced in some exemplary embodiments of the present disclosure.

Referring to an exemplary view 1310, as described above, the propeller of the driving unit 70 may be installed in the open type frame and in a flight mode of the drone 100, the open type frame outwardly slides in the left and right direction of the frame 10 while accommodating the propeller.

After completing the sliding, a first area 1301 of the open type frame is located outside the frame 10 and a second area 1302 is located in the frame 10.

The exemplary view 1320 is a plan view of the drone 100 and illustrates an opening unit 60 which introduces the air into the frame 10.

The driving unit 130 includes one or more propellers and the propellers rotate in response to the control command of the controller 160. When the propeller rotates, the second area 1302 of the open type frame and the propeller accommodated therein are located in the frame 10. As the propeller rotates, external air may be introduced through the opening unit 60 equipped in the frame 10 in an upper end direction of the second area 1302. That is, a suction force is generated in the second area 1302 toward the inside of the frame 10 by the rotation of the propeller and the external air is introduced by the suction force generated through the opening unit 60 of the frame 10. By doing this, the air is introduced and circulated in the frame 10 to cool the controller 160.

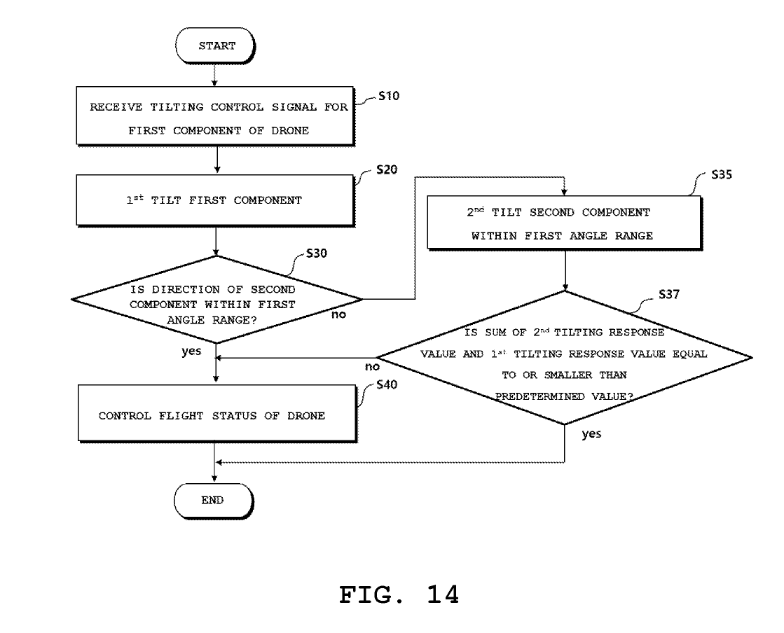

FIG. 14 is a flowchart of a control method of a camera drone according to still another exemplary embodiment of the present disclosure. Hereinafter, each step may be performed by each component under the control of the controller 160 of the drone 100.

The drone 100 may receive a tilting control signal for a first component of a camera drone in step S10. The first composition may be, for example, a camera 30.

The drone 100 may perform a first tilting on the first component in response to the reception of the control signal in step S20. Next, the drone 100 may determine whether the direction of second component is within the first angle range in response to the first tilting in step S30. For example, the second component may be a display 50. When the camera 30 rotates at a predetermined angle, the drone 100 may determine whether the direction of the second component is within the first angle range. For example, the first angle range may be an image output angle of the display 50 which is set with respect to the frame 10 of the drone 100 so as to comply with a viewing angle range of the user which is being shot by the camera 30.

As the determination result, when the direction of the second component is within the first angle range, the drone 100 may control the flight status based on the tilting information of the first component in step S40. For example, the flight status control of the drone 100 may be posture control of the drone 100 or control for changing a coordinate of the drone 100 on the three-dimensional space.

In contrast, when the direction of the second component is out of the first angle range, the drone 100 may perform a second tilting on the direction of the second component within the first angle range in step S35. In the above example, the display 50 may rotate so that the image output angle of the display 50 is within the first angle range.

Next, the drone 100 may determine whether a value obtained by adding a second tilting response value in accordance with the second tilting and a first tilting response value in accordance with the first tilting is equal to or smaller than a predetermined value. For example, the drone 100 may determine whether a sum of a reaction energy in accordance with the rotation of the camera 30 and a reaction energy in accordance with the rotation of the display 50 is equal to or smaller than a predetermined value. That is, the drone 100 adds a posture changed amount of the drone 100 caused by the rotation of the camera 30 and a posture changed amount of the drone 100 caused by the rotation of the display 50 to measure a final posture changed amount. The drone 100 may compare posture information before the first tilting and the second tilting and the finally changed posture information. In this case, a difference between the posture information before tilting and the posture information which is finally changed is equal to or smaller than the predetermined value and the drone 100 does not perform the posture correction. However, as the comparing result, when the sum exceeds the predetermined value, the drone 100 controls the flight status in step S40.

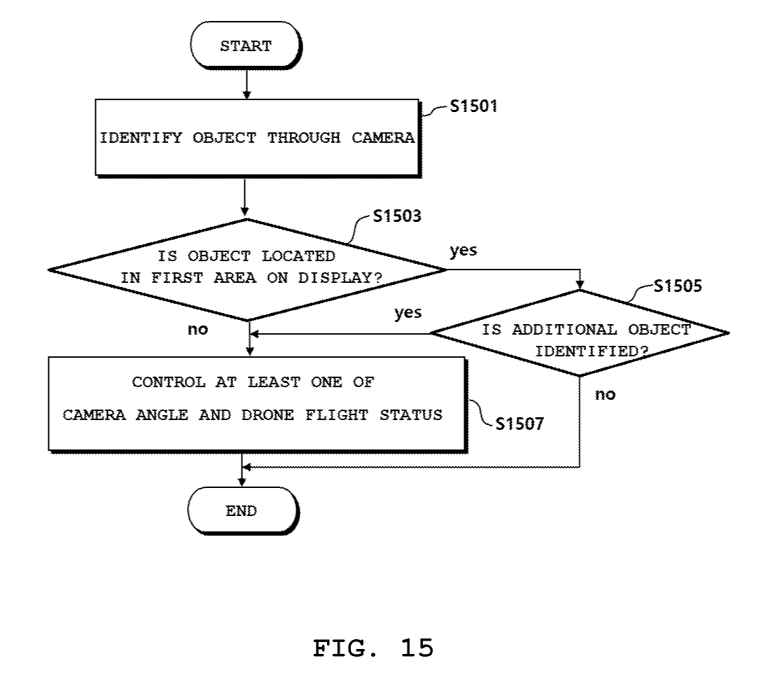

FIG. 15 is a flowchart of a shooting position changing method of a drone in accordance with an image analysis according to still another exemplary embodiment of the present disclosure. Hereinafter, each step may be performed by each component under the control of the controller 160 of the drone 100.

Referring to FIG. 15, the drone 100 identifies an object which is a subject, through the camera 30 in step S1501. Here, the object identification refers to identify that an image of the object is input to the camera 30 and also identify the size of the object and the number of objects.

The drone 100 may determine whether the object is located in the first area on the display 50 in step S1503. Here, the first area may be a part of the area of the display 50, for example, may be a center area of the display 50.

As the determination result, when the object is not located in the first area, the drone 100 may control to change at least one of an angle of the camera 30 and the flight status of the drone 100 in step S1507. By doing this, the drone 100 may change the angle of the camera 30 and/or the coordinate of the drone 100 on the three-dimensional space so as to output an image of the object into the first area on the display 50.

In contrast, when the object is located in the first area in step S1503, the drone 100 may determine whether an additional object is identified in step S1505. Here, the additional object is another object other than the object identified in step S1501 and is additionally identified by the camera 30 in addition to the object identified in step S1501.

As the result of the determination of identification of the additional object, when the additional object is identified, the drone 100 may change the angle of the camera and/or the coordinate of the drone 100 on the three-dimensional space so as to output images of the object identified in step S1501 and the additional object into the second area on the display 50. The second area may be the same area as the first area or may be another area including the first area. Further, in another exemplary embodiment, the second area may be an area which is separated from the first area.

The methods according to the embodiments of the present invention which have been described above with reference to the accompanying drawl so far may be performed by the execution of a computer program embodied in a computer readable code. The computer program is transmitted from the first computing device to the second computing device through a network such as the Internet to be installed in the second computing device so that the computer program may be used in the second computing device. The first computing device and the second computing device may include both a fixed computing device such as a server device and a desktop PC and a mobile computing device such as a notebook computer, a smart phone, or a tablet PC.

The exemplary embodiments of the present disclosure have been described with reference to the accompanying drawings, but those skilled in the art will understand that the present disclosure may be implemented in another specific form without changing the technical spirit or an essential feature thereof. Thus, it is to be appreciated that the embodiments described above are intended to be illustrative in every sense, and not restrictive.

What is claimed is:

1. A camera drone, comprising:
a frame;
a driving unit which is equipped in the frame and moves the camera drone;
a camera which is rotatable with respect to a first axis on the frame and shoots an object;
a display which is rotatable with respect to a second axis on the frame and outputs an image for the shot object; and
a controller which is mounted in the frame and controls at least one of the camera and the display to be rotated.

2. The camera drone according to claim 1, wherein the controller controls the camera to rotate from a first direction to a second direction and controls the driving unit to change a posture of the camera drone which is flying in accordance with the rotation of the camera from the first direction to the second direction.

3. The camera drone according to claim 1, wherein the controller controls the camera to rotate from a first direction to a second direction and rotates the display so as to adjust an image output direction in accordance with the rotation of the camera from the first direction to the second direction.

4. The camera drone according to claim 1, wherein when the camera is directed to a predetermined first direction, the controller rotates the display such that the image output direction is directed to a predetermined second direction.

5. The camera drone according to claim 4, further comprising:
a communication unit which receives a control signal for controlling the camera drone, from an external device,
wherein the controller identifies a direction of the external device as the control signal is received through the communication unit and sets the second direction based on a direction of the identified external device.

6. The camera drone according to claim 1, wherein the controller controls the display to rotate from a third direction to a fourth direction and controls the driving unit to change a posture of the camera drone which is flying in accordance with the rotation of the display from the third direction to the fourth direction.

7. The camera drone according to claim 1, wherein the controller controls the driving unit to move the camera drone from a first position to a second position and controls at least one of the camera and the display unit to rotate in accordance with the movement of the camera drone from the first position to the second position.

8. The camera drone according to claim 1, wherein the controller identifies the tilting of the image output through the display and controls the driving unit to output the image to be aligned on the display and as the driving unit is controlled, at least one of an altitude and a direction of the camera drone which is shooting the object is changed.

9. The camera drone according to claim 1, further comprising:
a communication unit which receives a control signal for controlling the camera drone, from an external device, wherein the controller identifies a coordinate of the external device as the control signal is received through the communication unit and controls the camera to shoot an image in an area set based on the coordinate of the external device as an object.

10. The camera drone according to claim 9, wherein the controller rotates the camera so that the image in the area set based on the coordinate of the external device is output in a predetermined area on the display.

11. The camera drone according to claim 9, wherein the controller controls the driving unit so that the image in the area set based on the coordinate of the external device is output in a predetermined area on the display unit, and as the driving unit is controlled, at least one of an altitude and a direction of the camera drone which is shooting the image in the area set based on the coordinate of the external device is changed.

12. The camera drone according to claim 1, wherein as a first object is recognized through the camera, the controller controls the driving unit to output an image for the first object to the predetermined first area of the display and as the driving unit is controlled, at least one of an altitude and a direction of the altitude of the camera drone which is shooting the first object is changed.

13. The camera drone according to claim 12, wherein as a second object is additionally recognized in addition to the first object recognized by the camera, the controller controls the driving unit to output an image for the first object and an image for the second object to a predetermined second area of the display and as the driving unit is controlled, at least one of an altitude and a direction of the camera drone which is shooting the first object and the second object is changed.

14. The camera drone according to claim 1, wherein the frame further includes an opening unit to introduce external air into the frame, the driving unit includes a propeller which rotates in response to a control command of the controller and at least a part of propeller is located in the frame at the time of rotation, and as the propeller rotates in response to the control command of the controller, a suction force is generated into the frame through the opening unit and the external air is introduced through the opening unit of the frame by the suction force.

15. The camera drone according to claim 1, wherein the frame further includes a user input unit at one side of the frame, and the controller controls the driving unit to stop supplying a power to the propeller included in the driving unit as continuous user inputs are input through the user input unit and when the user input is released, the controller controls the driving unit to supply a power for hovering the drone to the propeller.
